(19) United States
(12) Patent Application Publication
(10) Pub. No.: US 2026/0200193 A1
(43) Pub. Date: Jul. 16, 2026

(54) Sole Forming Device and Method Thereof

(71) Applicant: KING STEEL MACHINERY CO., LTD., TAICHUNG CITY (TW)

(72) Inventor: Fa-Shen CHEN, TAICHUNG CITY (TW)

(21) Appl. No.: 19/441,442

(22) Filed: Jan. 6, 2026

Related U.S. Application Data
(60) Provisional application No. 63/744,698, filed on Jan. 13, 2025.

(51) Int. Cl. B29D 35/12; B29C 45/14; B29C 45/17; B29D 35/00; B29L 31/50

(52) U.S. Cl. CPC B29D 35/122; B29C 45/14008; B29D 35/0018; B29C 2045/1785; B29L 2031/504

(57) ABSTRACT

Sole forming device includes a base, first mold, second mold, linkage mechanism, first and second shoe lasts detachably attached to second mold. First mold has first and second mold bodies arranged adjacently on the base. First and second mold bodies have first and second cavities defined therein and opening outward respectively. Second mold is spaced apart from first mold and movable between second mold-opening position spaced from first mold and second mold-closing position abutting first mold. Second mold-opening position enables first and second shoe lasts to move synchronously with second mold away from first mold. Second mold-closing position enables first and second shoe lasts to be inserted into first and second cavities respectively. Linkage mechanism moves mold bodies from first mold-opening position to first mold-closing position such that sole forming space is defined between first cavity and first shoe last and defined between second cavity and second shoe last.

### FIELD OF THE INVENTION

The present disclosure relates to molding and forming processing technology, and more particularly to a sole forming device and method thereof.

### DESCRIPTION OF THE RELATED ART

Conventional sole forming equipment can usually perform forming operations on only one set of soles at a time, which leads to lower production efficiency. In addition, conventional sole forming equipment typically has more complex structural components, resulting in increased maintenance and operation costs. Furthermore, when multiple sets of sole forming equipment are combined to simultaneously perform forming operations for multiple sets of soles, inconsistencies in actuation among the different pieces of equipment often occur, thereby adversely affecting the quality of the final product. Therefore, it is imperative to provide an alternative method to overcome the aforementioned drawbacks.

### SUMMARY OF THE INVENTION

It is an objective of the disclosure to provide a sole forming device having simplified structural components, capable of synchronously performing a forming operation on two sets of soles, while maintaining actuation consistency and precision between the two sets of soles during the forming operation.

To achieve the above and other objectives, the disclosure provides a sole forming device, comprising a base, a first mold, a linkage mechanism, a second mold, a first shoe last, and a second shoe last. The first mold has a first mold body and a second mold body. The first and second mold bodies are arranged side by side on the base. The first mold body has a first cavity defined therein and opening outward, and the second mold body has a second cavity defined therein and opening outward. The linkage mechanism is connected to the first mold body and the second mold body and configured to synchronously drive the first mold body and the second mold body to move between a first mold-opening position and a first mold-closing position. The second mold is spaced apart from the first mold and configured to move between a second mold-opening position spaced apart from the first mold and a second mold-closing position abutting the first mold. The first shoe last and the second shoe last are sleeved by a first fitting member and a second fitting member respectively, arranged side by side, and detachably attached to the second mold. The first and second shoe lasts move synchronously with the second mold away from the first mold when the second mold is at the second mold-opening position, and the first and second shoe lasts are inserted into the first and second cavities respectively when the second mold is at the second mold-closing position. Changing the positions of the first mold body and the second mold body causes the linkage mechanism to simultaneously drive the first mold body and the second mold body to move from the first mold-closing position to the first mold-opening position. Then, changing the position of the second mold causes the second mold to move from the second mold-opening position to the second mold-closing position. Next, the linkage mechanism simultaneously drives the first mold body and the second mold body to move from the first mold-opening position to the first mold-closing position to define a first sole forming space between an inner wall surface of the first cavity and an outer periphery of the first shoe last and define a second sole forming space between an inner wall surface of the second cavity and an outer periphery of the second shoe last. Therefore, a sole forming operation can be synchronously performed.

In an embodiment, the second mold and the first mold move relative to each other along a virtual first axial direction; wherein the first mold body comprises a first mold member, a second mold member, and a third mold member, the first and second mold members being spaced apart and configured to extend along a virtual second axial direction perpendicular to the first axial direction, and the third mold member being disposed between the first mold member and the second mold member; wherein the second mold body comprises a fourth mold member, a fifth mold member, and a sixth mold member, the fourth and fifth mold members being spaced apart and configured to extend along the second axial direction, and the sixth mold member being disposed between the fourth mold member and the fifth mold member; wherein the linkage mechanism is connected to the first mold member, the second mold member, the fourth mold member, and the fifth mold member to drive the first, second, fourth and fifth mold members to be synchronously actuated and move along the second axial direction between the first mold-opening position and the first mold-closing position; wherein, when the first mold member and the second mold member are at the first mold-closing position, the third mold member is clampedly disposed between the first mold member and the second mold member, and the sixth mold member is clampedly disposed between the fourth mold member and the fifth mold member; wherein the first mold member, the second mold member, and the third mold member together define the first cavity, and the first cavity is in communication with an exterior through a first aperture; wherein the fourth mold member, the fifth mold member, and the sixth mold member together define the second cavity, and the second cavity is in communication with the exterior through a second aperture; wherein, when the first and second mold members are at the first mold-opening position, the first and second mold members are positioned distal to the third mold member, and the fourth and fifth mold members are positioned distal to the sixth mold member.

In an embodiment, to achieve synchronous actuation, the linkage mechanism comprises: a guide portion extending along the second axial direction; a first moving portion slidably disposed on the guide portion and configured to carry the first mold body; a first driving portion configured to drive the first moving portion to slide on the guide portion and drive the first mold body to move together with the first moving portion; a second moving portion spaced apart from the first moving portion, slidably disposed on the guide portion, and configured to carry the second mold body; and a second driving portion configured to drive the second moving portion to slide on the guide portion and drive the second mold body to move together with the second moving portion.

In an embodiment, the guide portion comprises a first guide rod and a second guide rod, the first and second guide rods being parallel, spaced apart, and configured to extend along the second axial direction.

In an embodiment, the first moving portion comprises a first sliding block and a second sliding block, the first sliding block extending across, being slidably disposed on the first guide rod and the second guide rod, and being configured to carry the first mold member, and the second sliding block being spaced apart from the first sliding block, extending across and being slidably disposed on the first guide rod and the second guide rod, and being configured to carry the second mold member; wherein the second moving portion comprises a third sliding block and a fourth sliding block, the third sliding block extending across, being slidably disposed on the first guide rod and the second guide rod, and being configured to carry the third mold member, and the fourth sliding block being spaced apart from the third sliding block, extending across and being slidably disposed on the first guide rod and the second guide rod, and being configured to carry the fourth mold member.

In an embodiment, the first driving portion comprises a first power source, a first connecting member, and a first linkage member; wherein the first connecting member is disposed between the first power source and the first sliding block such that the first sliding block is driven by the first power source to move away from or toward the second sliding block; wherein the first linkage member is disposed between the first sliding block and the fourth sliding block and configured to cause the fourth sliding block to move toward the third sliding block when the first sliding block is driven to move toward the second sliding block; wherein the second driving portion comprises a third power source and a second connecting member; wherein the second connecting member is disposed between the third power source and the third sliding block such that the third sliding block is driven by the third power source to move away from or toward the fourth sliding block; wherein the second linkage member is disposed between the third sliding block and the second sliding block and configured to cause the second sliding block to move toward the first sliding block when the third sliding block is driven to move toward the fourth sliding block.

In an embodiment, the first connecting member comprises a first pivot seat, a second pivot seat, a first swing arm and a second swing arm, the first and second pivot seats being spaced apart and disposed on the first sliding block, the first swing arm having an end connected to the first pivot seat and another end connected to the first power source, and the second swing arm having an end connected to the second pivot seat and another end connected to the first power source; wherein the second connecting member comprises a third pivot seat, a fourth pivot seat, a third swing arm, and a fourth swing arm, the third and fourth pivot seats being spaced apart and disposed on the third sliding block, the third swing arm having an end connected to the third pivot seat and another end connected to the third power source, and the fourth swing arm having an end connected to the fourth pivot seat and another end connected to the third power source.

In an embodiment, the first linkage member comprises a first push rod and a second push rod, the first push rod being disposed on the first sliding block, being positioned proximate to the first guide rod, and extending along the second axial direction toward the fourth sliding block, and the second push rod being disposed on the first sliding block, being positioned proximate to the second guide rod, and extending along the second axial direction toward the fourth sliding block; wherein, when the first sliding block moves toward the second sliding block and becomes positioned proximate to the second sliding block, both the first push rod and the second linkage member abut the fourth sliding block, move together with the first sliding block, and push the fourth sliding block to cause the fourth sliding block to move toward the third sliding block; wherein the second linkage member comprises a third push rod and a fourth push rod, the third push rod being disposed on the third sliding block, being positioned proximate to the first guide rod, and extending along the second axial direction toward the second sliding block, and the fourth push rod being disposed on the third sliding block, being positioned proximate to the second guide rod, and extending along the second axial direction toward the second sliding block; wherein, when the third sliding block moves toward the fourth sliding block and becomes positioned proximate to the fourth sliding block, both the third push rod and the fourth linkage member abut the second sliding block, move together with the third sliding block, and push the second sliding block to cause the second sliding block to move toward the first sliding block.

In an embodiment, the first fitting member and the second fitting member are shoe uppers, or the first fitting member and the second fitting member are shoe-socks.

The disclosure further provides a sole forming method, using the sole forming device, the sole forming method comprising:
step a: providing a first mold and a second mold, wherein the second mold is movable between a second mold-opening position spaced apart from the first mold and a second mold-closing position abutting the first mold;
step b: providing a first shoe last and a second shoe last that are respectively sleeved by a first fitting member and a second fitting member, arranged side by side, and detachably attached to the second mold;
step c: changing positions of a first mold body and a second mold body of the first mold through a linkage mechanism so as to move the first mold body and the second mold body from a first mold-closing position to a first mold-opening position;
step d: changing a position of the second mold so as to move the second mold from the second mold-opening position to the second mold-closing position and synchronously move the first shoe last and the second shoe last together with the second mold such that the first shoe last is inserted into the first cavity of the first mold body and the second shoe last is inserted into the second cavity of the second mold body;
step e: simultaneously driving, through the linkage mechanism, the first mold body and the second mold body to move from the first mold-opening position to the first mold-closing position so as to define a first sole forming space between an inner wall surface of the first cavity and an outer periphery of the first shoe last and define a second sole forming space between an inner wall surface of the second cavity and an outer periphery of the second shoe last; and
step f: introducing a first shoe raw material and a second shoe raw material into the first sole forming space and the second sole forming space respectively such that the first shoe raw material integrally encapsulates the first fitting member and the second shoe raw material integrally encapsulates the second fitting member.

### BRIEF DESCRIPTION OF DRAWINGS

FIG. 1 is a perspective view of a sole forming device according to the first embodiment of the disclosure.

FIG. 2 is an exploded view of the sole forming device according to the first embodiment of the disclosure.

FIG. 3 is a cross-sectional view taken along line 3-3 of FIG. 1.

FIG. 4 is a schematic view illustrating an operation subsequent to that shown in FIG. 3.

FIG. 5 is a schematic view illustrating an operation subsequent to that shown in FIG. 4.

FIG. 6 is a schematic view illustrating an operation subsequent to that shown in FIG. 5.

FIG. 7 is a schematic view illustrating an operation subsequent to that shown in FIG. 6.

FIG. 8 is a schematic view illustrating FIG. 6 from another perspective.

FIG. 9 is a schematic view illustrating FIG. 7 from another perspective.

FIG. 10 is a schematic view of the sole forming device according to the second embodiment of the disclosure.

FIG. 11 is a perspective view related to FIG. 10.

FIG. 12 is a perspective view illustrating FIG. 11 from another perspective.

FIG. 13 is a cross-sectional view taken along line 13-13 of FIG. 11.

FIG. 14 is a cross-sectional view taken along line 14-14 of FIG. 10.

### DETAILED DESCRIPTION OF THE INVENTION

The following embodiments of the disclosure are illustrated with reference to the accompanying drawings for further explanation.

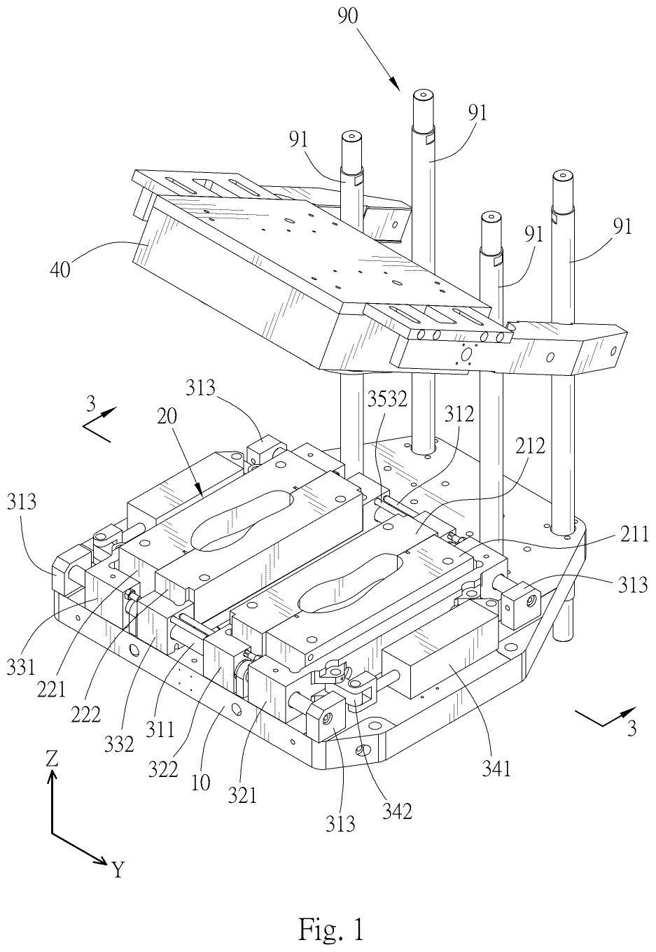

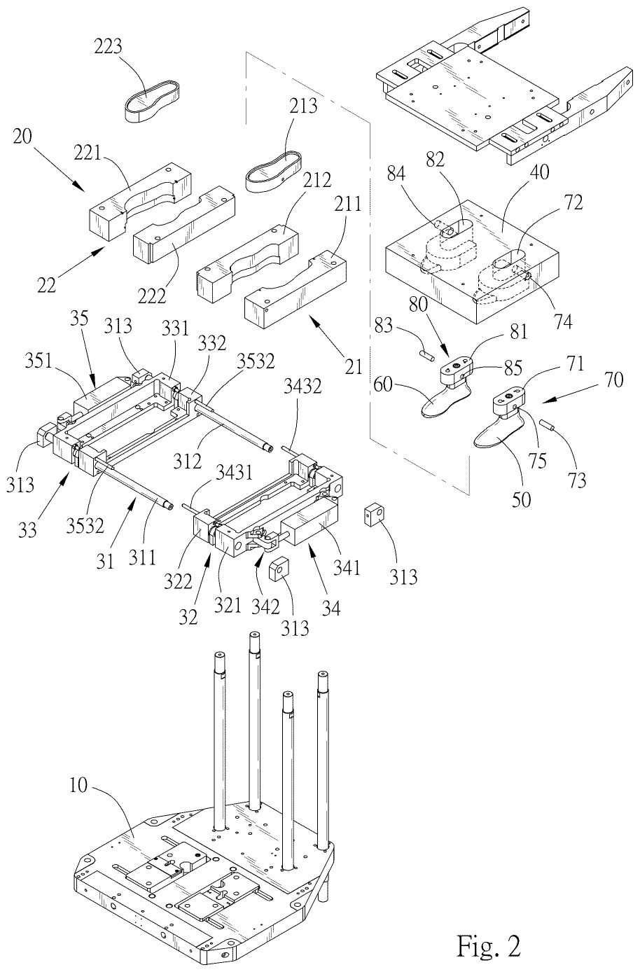

Referring to FIG. 1 through FIG. 3, the first embodiment of the disclosure provides a sole forming device comprising a base 10, a first mold 20, a linkage mechanism 30, a second mold 40, a first shoe last 50, a second shoe last 60, a first coupling portion 70, and a second coupling portion 80.

The base 10 is a plate body configured to carry the first mold 20.

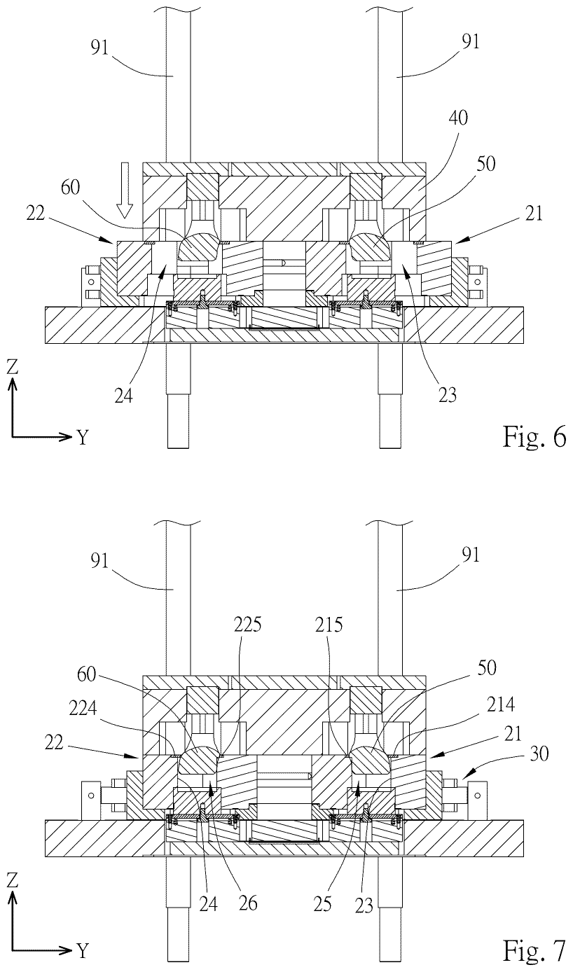

The first mold 20 and the second mold 40 are spaced apart and disposed along a virtual first axial direction Z. The first axial direction Z is the direction of gravity. The second mold 40 and the first mold 20 are driven by a mold clamping mechanism 90 to move along the first axial direction Z such that the second mold 40 moves between a second mold-opening position (as shown in FIG. 5) spaced apart from the first mold 20 and a second mold-closing position (as shown in FIG. 6) abutting the first mold 20. The adjacent end surfaces of the first mold 20 and the second mold 40 face each other and are complementary in shape, for example, planar surfaces or complementarily curved surfaces. The mold clamping mechanism 90 comprises a plurality of guide rods 91 disposed between the second mold 40 and the first mold 20, and at least one driving source (not shown) that functions as a source of power, for example, a hydraulic cylinder or pneumatic cylinder. The mold clamping technology employed by the mold clamping mechanism 90 falls within the field of prior art well known to those skilled in the art, is not the focus of the disclosure, and thus is not further elaborated herein.

The first mold 20 has a first mold body 21, a second mold body 22, a first cavity 23, and a second cavity 24. The first mold body 21 and the second mold body 22 are arranged side by side on the base 10. The first mold body 21 has the first cavity 23 defined therein and opening outward. The second mold body 22 has the second cavity 24 defined therein and opening outward. The first mold body 21 has a first mold member 211, a second mold member 212, and a third mold member 213. The first mold member 211 and the second mold member 212 are spaced apart from each other and arranged along a virtual second axial direction Y perpendicular to the first axial direction Z. The third mold member 213 is disposed between the first mold member 211 and the second mold member 212 and disposed on the base 10. The second mold body 22 has a fourth mold member 221, a fifth mold member 222, and a sixth mold member 223. The fourth mold member 221 and the fifth mold member 222 are spaced apart from each other and arranged along the second axial direction Y. The sixth mold member 223 is disposed between the fourth mold member 221 and the fifth mold member 222. The sixth mold member 223 and the third mold member 213 are spaced apart from each other and disposed on the base 10. However, the above embodiment is illustrative rather than restrictive of any other aspects of implementation of the first mold body 21 and the second mold body 22. The third mold member 213 has at least one first recess (not shown) for receiving at least one first outsole color block (not shown). The sixth mold member 223 has at least one second recess (not shown) for receiving at least one second outsole color block (not shown).

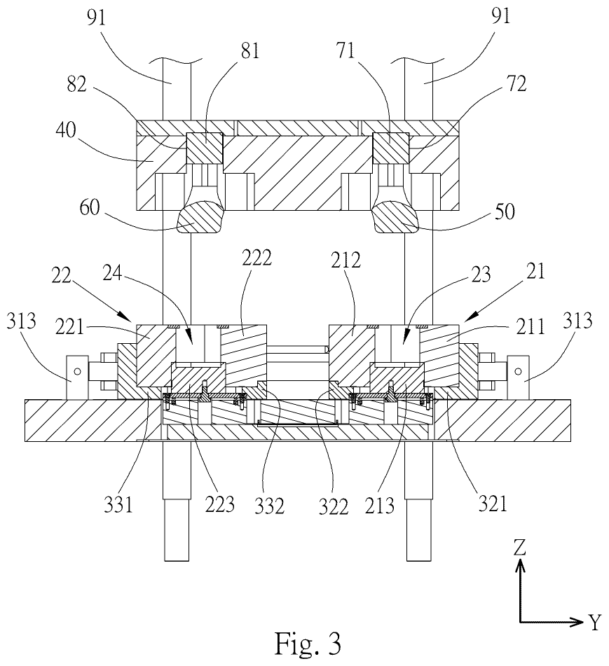

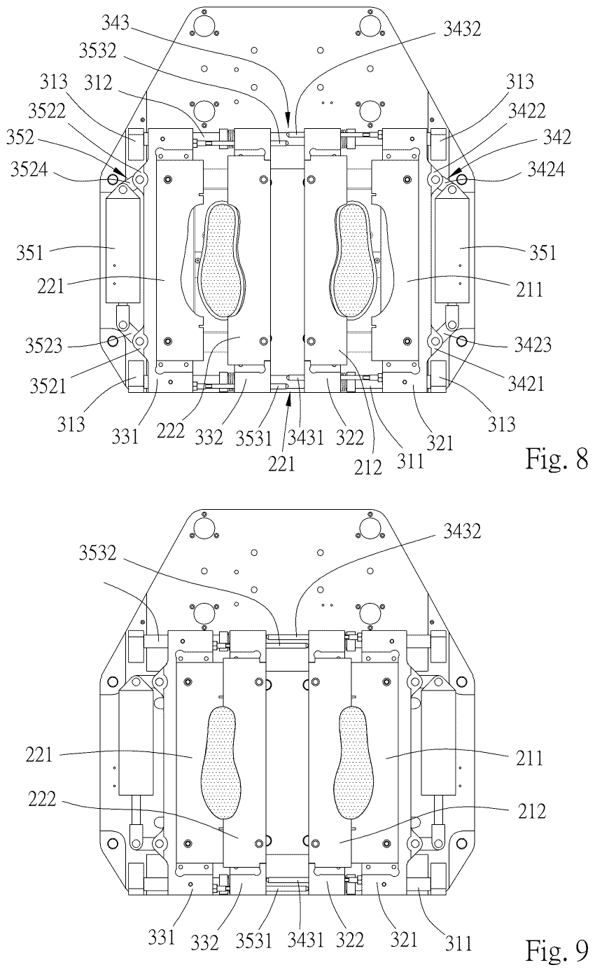

The linkage mechanism 30 is connected to the first mold body 21 and the second mold body 22 to synchronously drive the first mold body 21 and the second mold body 22 to move between a first mold-opening position (as shown in FIG. 6 and FIG. 8) and a first mold-closing position (as shown in FIG. 7 and FIG. 9). As shown in FIG. 7 and FIG. 9, when the first mold member 211 and the second mold member 212 are at the first mold-closing position, the third mold member 213 is clampedly disposed between the first mold member 211 and the second mold member 212, and the sixth mold member 223 is clampedly disposed between the fourth mold member 221 and the fifth mold member 222. The region jointly enclosed by the first mold member 211, the second mold member 212 and the third mold member 213 is defined as the first cavity 23. The adjacent end surfaces of the first mold member 211, the second mold member 212 and the third mold member 213 face each other and are complementary in shape, and a first aperture 231 is provided to communicate with the exterior (as shown in FIG. 3). The first cavity 23 is in communication with the exterior through a first aperture 231 (as shown in FIG. 3). The region jointly enclosed by the fourth mold member 221, the fifth mold member 222 and the sixth mold member 223 is defined as the second cavity 24. The second cavity 24 is in communication with the exterior through a second aperture 241 (as shown in FIG. 3). As shown in FIG. 6 and FIG. 8, when the first mold member 211 and the second mold member 212 are at the first mold-opening position, the first mold member 211 and the second mold member 212 move away from each other in a direction away from the third mold member 213, and the fourth mold member 221 and the fifth mold member 222 move away from each other in a direction away from the sixth mold member 223. The third mold member 213 has a first injection channel (not shown) in communication with the first cavity 23 for introducing a first shoe raw material (not shown). The sixth mold member 223 has a second injection channel (not shown) in communication with the second cavity 24 for introducing a second shoe raw material (not shown). In another possible embodiment, the injection channels may alternatively be disposed on other mold members as appropriate.

The linkage mechanism 30 comprises a guide portion 31, a first moving portion 32, a second moving portion 33, a first driving portion 34, and a second driving portion 35. The guide portion 31 extends along the second axial direction Y. The first moving portion 32 is slidably disposed on the guide portion 31 and configured to carry the first mold body 21. The first driving portion 34 not only drives the first moving portion 32 to slide along the guide portion 31 but also causes the first mold body 21 to move as a result of the actuation of the first moving portion 32. The second moving portion 33 is spaced apart from the first moving portion 32, slidably disposed on the guide portion 31, and configured to carry the second mold body 22. The second driving portion 35 not only drives the second moving portion 33 to slide along the guide portion 31 but also causes the second mold body 22 to move as a result of the actuation of the second moving portion 33.

The guide portion 31 comprises a first guide rod 311 and a second guide rod 312, which are parallel and spaced apart from each other, each supported by an end fixing block 313 at both ends of the rods and by a middle fixing block 314 at the middle segments of the rods, thereby allowing the first and second guide rods 311, 312 to be elevated and fixed to the base 10. The first guide rod 311 and the second guide rod 312 extend along the second axial direction Y.

The first moving portion 32 comprises a first sliding block 321 and a second sliding block 322. The first sliding block 321 extends across the first guide rod 311 and the second guide rod 312 and is slidably disposed on the first and second guide rods 311, 312 to carry the first mold member 211. The second sliding block 322, spaced apart from the first sliding block 321, extends across the first guide rod 311 and the second guide rod 312 and is slidably disposed on the first and second guide rods 311, 312 to carry the second mold member 212.

The second moving portion 33 comprises a third sliding block 331 and a fourth sliding block 332. The third sliding block 331 extends across the first guide rod 311 and the second guide rod 312 and is slidably disposed on the first and second guide rods 311, 312 to carry the third mold member 213. The fourth sliding block 332, spaced apart from the third sliding block 331, extends across the first guide rod 311 and the second guide rod 312 and is slidably disposed on the first and second guide rods 311, 312 to carry the fourth mold member 221.

The first driving portion 34 comprises a first power source 341, a first connecting member 342, a first linkage member 343, and two second power sources 344. The first power source 341 may be, but is not limited to, a hydraulic cylinder or a pneumatic cylinder (The associated fluid conduits are omitted from illustration). The first connecting member 342 is disposed between the first power source 341 and the first sliding block 321. The first sliding block 321, driven by the first power source 341, moves away from or toward the second sliding block 322 under the guidance of the first guide rod 311 and the second guide rod 312. In this embodiment, the second power sources 344 are exemplified by compression springs sleeved respectively around the first guide rod 311 and the second guide rod 312, each having opposite ends respectively abutting the second sliding block 322 and the middle fixing blocks 314, so as to exert an elastic force urging the second sliding block 322 toward the first mold-opening position. The first linkage member 343 is disposed between the first sliding block 321 and the fourth sliding block 332. When the first sliding block 321 is driven toward the second sliding block 322, the first linkage member 343 drives the fourth sliding block 332 to move toward the third sliding block 331.

The first connecting member 342 comprises a first pivot seat 3421, a second pivot seat 3422, a first swing arm 3423, and a second swing arm 3424. The first pivot seat 3421 and the second pivot seat 3422 are spaced apart and disposed on the first sliding block 321. The first swing arm 3423 has one end connected to the first pivot seat 3421 and the other end connected to the first power source 341. The second swing arm 3424 has one end connected to the second pivot seat 3422 and the other end connected to the first power source 341.

The first linkage member 343 comprises a first push rod 3431 and a second push rod 3432. The first push rod 3431, disposed on the first sliding block 321 and positioned alongside the first guide rod 311, extends along the second axial direction Y toward the fourth sliding block 332. The second push rod 3432, disposed on the first sliding block 321 and positioned alongside the second guide rod 312, extends along the second axial direction Y toward the fourth sliding block 332. When the first sliding block 321 moves toward and approaches the second sliding block 322, both the first push rod 3431 and the second linkage member simultaneously abut the fourth sliding block 332 and, as the first sliding block 321 continues to move, push the fourth sliding block 332 toward the third sliding block 331.

The second driving portion 35 comprises a third power source 351, a second connecting member 352, a second linkage member 353, and two fourth power sources 354. The third power source 351 may be, but is not limited to, a hydraulic cylinder or a pneumatic cylinder (The associated fluid conduits are omitted from illustration.) The second connecting member 352 is disposed between the third power source 351 and the third sliding block 331. The third sliding block 331, driven by the third power source 351, moves away from or toward the fourth sliding block 332 under the guidance of the first guide rod 311 and the second guide rod 312. In this embodiment, the fourth power sources 354 are exemplified by compression springs sleeved respectively around the first guide rod 311 and the second guide rod 312, each having opposite ends respectively abutting the fourth sliding block 332 and the middle fixing blocks 314, so as to exert an elastic force urging the fourth sliding block 332 toward the first mold-opening position. The second linkage member 353 is disposed between the third sliding block 331 and the second sliding block 322. When the third sliding block 331 is driven toward the fourth sliding block 332, the second linkage member 353 drives the second sliding block 322 to move toward the first sliding block 321.

The second connecting member 352 comprises a third pivot seat 3521, a fourth pivot seat 3522, a third swing arm 3523, and a fourth swing arm 3524. The third pivot seat 3521 and the fourth pivot seat 3522 are spaced apart and disposed on the third sliding block 331. The third swing arm 3523 has one end connected to the third pivot seat 3521 and the other end connected to the third power source 351. The fourth swing arm 3524 has one end connected to the fourth pivot seat 3522 and the other end connected to the third power source 351.

The second linkage member 353 comprises a third push rod 3531 and a fourth push rod 3532. The third push rod 3531, disposed on the third sliding block 331 and positioned alongside the first guide rod 311, extends along the second axial direction Y toward the second sliding block 322. The fourth push rod 3532, disposed on the third sliding block 331 and positioned alongside the second guide rod 312, extends along the second axial direction Y toward the second sliding block 322. When the third sliding block 331 moves toward and approaches the fourth sliding block 332, both the third push rod 3531 and the fourth linkage member simultaneously abut the second sliding block 322 and, as the third sliding block 331 continues to move, push the second sliding block 322 toward the first sliding block 321.

The first shoe last 50 and the second shoe last 60 are respectively sleeved by a first fitting member (not shown) and a second fitting member (not shown), arranged side by side, and detachably attached to the second mold 40. The first fitting member and the second fitting member are respectively shoe uppers, or the first fitting member and the second fitting member are respectively shoe-socks. The material of the shoe uppers or the shoe-socks may be, but is not limited to, leather, synthetic leather, fabric, suede, or textile.

The first shoe last 50 and the second shoe last 60 are respectively connected to the second mold 40 through the first coupling portion 70 and the second coupling portion 80. The first coupling portion 70 comprises a first connecting rod 71 and a first slot 72. The first connecting rod 71 is fixedly disposed on the first shoe last 50. The first slot 72 is formed in the second mold 40 for insertion of the first connecting rod 71. The second coupling portion 80 comprises a second connecting rod 81 and a second slot 82. The second connecting rod 81 is fixedly disposed on the second shoe last 60. The second slot 82 and the first slot 72 are spaced apart, disposed on the second mold 40, and configured for insertion of the second connecting rod 81. The first coupling portion 70 further comprises a first pin 73, a first through hole 74, and a second through hole 75. The first through hole 74 is formed in the second mold 40, corresponds in position to the first slot 72, and is in communication with the first slot 72. The second through hole 75 is formed in the first connecting rod 71 and corresponds in position to the first through hole 74. After the first connecting rod 71 has been inserted into the first slot 72, the first pin 73 is removably inserted through the first through hole 74 and the second through hole 75 to fix the first shoe last 50 to the second mold 40. The second coupling portion 80 further comprises a second pin 83, a third through hole 84, and a fourth through hole 85. The third through hole 84 is formed in the second mold 40, corresponds in position to the second slot 82, and is in communication with the second slot 82. The fourth through hole 85 is formed in the second connecting rod 81 and corresponds in position to the third through hole 84. After the second connecting rod 81 has been inserted into the second slot 82, the second pin 83 is removably inserted through the third through hole 84 and the fourth through hole 85 to fix the second shoe last 60 to the second mold 40.

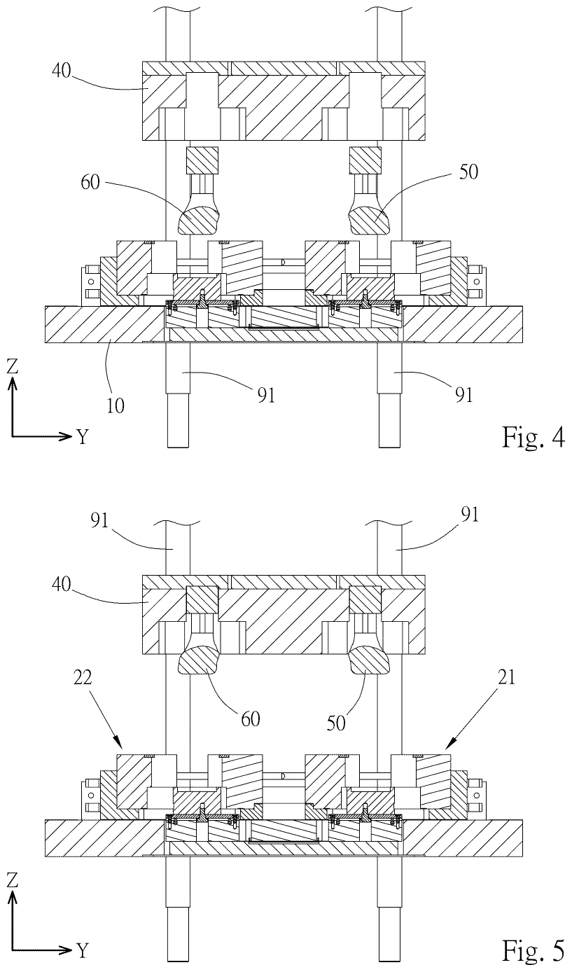

Referring to FIG. 4 through FIG. 9, given the aforementioned structural features, the disclosure further provides a sole forming method comprising steps as follows:
step a: providing a first mold 20 and a second mold 40, wherein the second mold 40 is movable between a second mold-opening position spaced apart from the first mold 20 and a second mold-closing position abutting the first mold 20;
step b: providing a first shoe last 50 and a second shoe last 60 (as shown in FIG. 4) that are respectively sleeved by a first fitting member and a second fitting member, arranged side by side, and detachably attached to the second mold 40 as shown in FIG. 5;
step c: changing the positions of a first mold body 21 and a second mold body 22 of the first mold 20 through a linkage mechanism 30, thereby moving the first mold body 21 and the second mold body 22 from a first mold-closing position (as shown in FIG. 3) to a first mold-opening position (as shown in FIG. 5);
step d: changing the position of the second mold 40, thereby moving the second mold 40 from the second mold-opening position to the second mold-closing position, and synchronously moving the first shoe last 50 and the second shoe last 60 together with the second mold 40 to not only allow the first shoe last 50 to be inserted into the first cavity 23 of the first mold body 21 but also allow the second shoe last 60 to be inserted into the second cavity 24 of the second mold body 22 as shown in FIG. 6;
step e: simultaneously driving, through the linkage mechanism 30, the first mold body 21 and the second mold body 22 to move from the first mold-opening position (as shown in FIG. 6 and FIG. 8) to the first mold-closing position (as shown in FIG. 7 and FIG. 9) to not only define a first sole forming space 25 between an inner wall surface of the first cavity 23 and an outer periphery of the first shoe last 50 (as shown in FIG. 7) but also define a second sole forming space 26 between an inner wall surface of the second cavity 24 and an outer periphery of the second shoe last 60 (as shown in FIG. 7);
step f: introducing a first shoe raw material and a second shoe raw material into the first sole forming space 25 and the second sole forming space 26 respectively to allow the first shoe raw material to integrally encapsulate the first fitting member and allow the second shoe raw material to integrally encapsulate the second fitting member. Therefore, the first shoe raw material and the second shoe raw material are configured for use in forming a shoe upper and sole respectively and thus are coupled to the first fitting member and the second fitting member to not only allow a shoe to be made but also allow the first outsole color block and the second outsole color block to correspond in position to a sole forming portion. In yet another possible embodiment, the resultant structure derived from the first shoe raw material and the second shoe raw material is restricted to the sole of the shoe formed.

Regarding step e, the first mold body 21 further comprises a first partition portion 214 disposed on the first mold member 211 and a second partition portion 215 disposed on the second mold member 212. In the situation where the first shoe last 50 is inserted into the first mold 20 through the first aperture 231 and the first mold body 21 is located at the first mold-closing position, both the first partition portion 214 and the second partition portion 215 not only press against the outer periphery of the first shoe last 50 exactly as shown in FIG. 7 but also complement opposing adjacent end surfaces at the outer periphery of the first shoe last 50 in terms of shape respectively, thereby allowing the first shoe last 50 itself, the first partition portion 214 and the second partition portion 215 to jointly provide a hermetic seal to the first aperture 231. Likewise, the second mold body 22 further comprises a third partition portion 224 disposed on the fourth mold member 221 and a fourth partition portion 225 disposed on the fifth mold member 222. In the situation where the second shoe last 60 is inserted into the second mold 40 through the second aperture 241 and the second mold body 22 is located at the first mold-closing position, both the third partition portion 224 and the fourth partition portion 225 not only press against the outer periphery of the second shoe last 60 exactly as shown in FIG. 7 but also complement opposing adjacent end surfaces at the outer periphery of the second shoe last 60 in terms of shape respectively, thereby allowing the second shoe last 60 itself, the third partition portion 224 and the fourth partition portion 225 to jointly provide a hermetic seal to the second aperture 241. In still yet another possible embodiment, the first shoe last 50 itself hermetically seals the first aperture 231 when inserted into the first mold 20 through the first aperture 231, and the second shoe last 60 itself hermetically seals the second aperture 241 when inserted into the second mold 40 through the second aperture 241. In a further possible embodiment, when the second mold 40 is located at the second mold-closing position, different portions of the second mold 40 hermetically seal the first aperture 231 and the second aperture 241 respectively.

Therefore, the sole forming method of the disclosure is effective in synchronously making two sets of soles, especially the soles for the left foot and right foot for wearing the same set of shoes, and enabling each of the soles to be integrally coupled to a shoe upper or shoe-sock in a manner that dispenses with any complicated production steps but ensures effective enhancement of production efficiency.

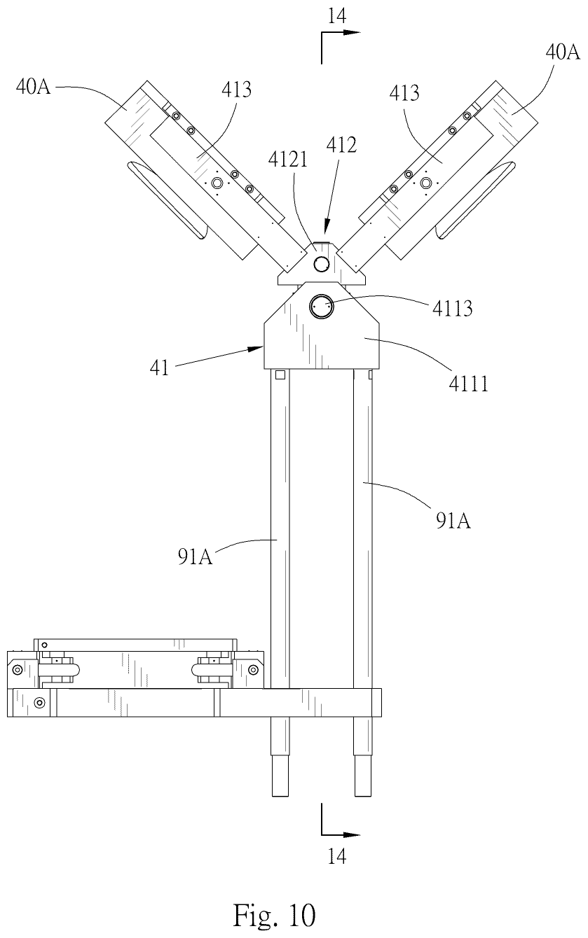

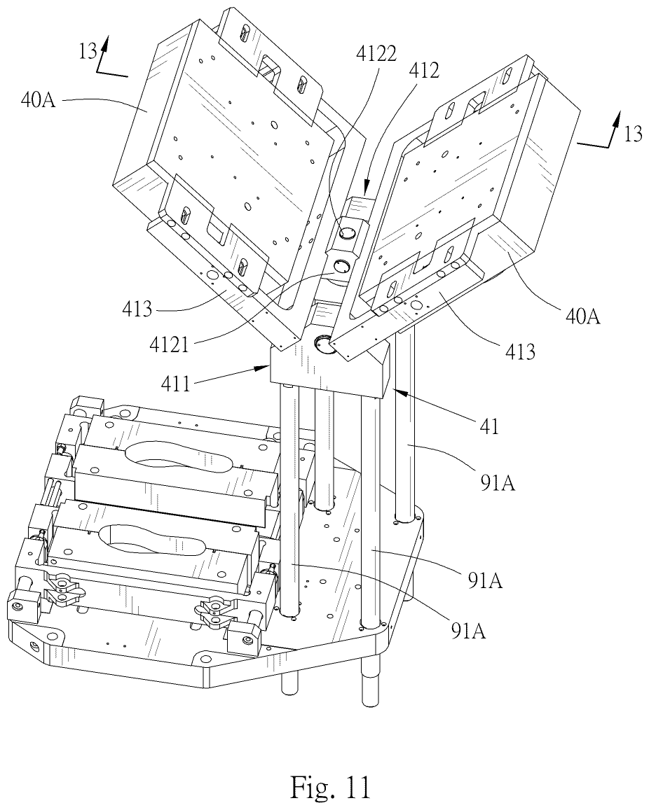

As shown in FIG. 10 through FIG. 14, the second embodiment of the disclosure is illustrated. Unlike the first embodiment, the second embodiment provides: two second molds 40A; and a mold replacement base 41 disposed on guide rods 91A and configured to carry the second molds 40A, such that the second molds 40A can be swapped using the mold replacement base 41 so as to meet different forming needs or quickly perform mold maintenance.

The mold replacement base 41 comprises a fixing portion 411, an actuating portion 412, and two carrying portions 413. The fixing portion 411 is fixed to the guide rods 91A to provide firm support. The actuating portion 412 is movably disposed on the fixing portion 411 and actuated relative to the fixing portion 411. The carrying portions 413 are spaced apart, disposed on two opposing sides of the actuating portion 412, and configured to carry the second molds 40A respectively. When the actuating portion 412 is actuated, the actuating portion 412 drives the carrying portions 413 to move such that the second molds 40A swap positions in order to be applicable to a forming operation or achieve mold replacement. Therefore, the second embodiment is effective in speeding up mold replacement and enhancing the production efficiency of the forming operation.

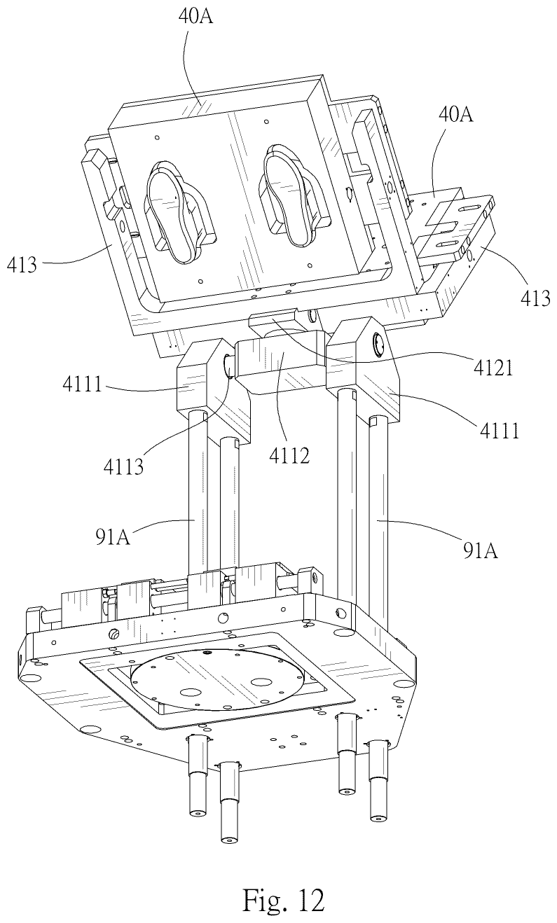

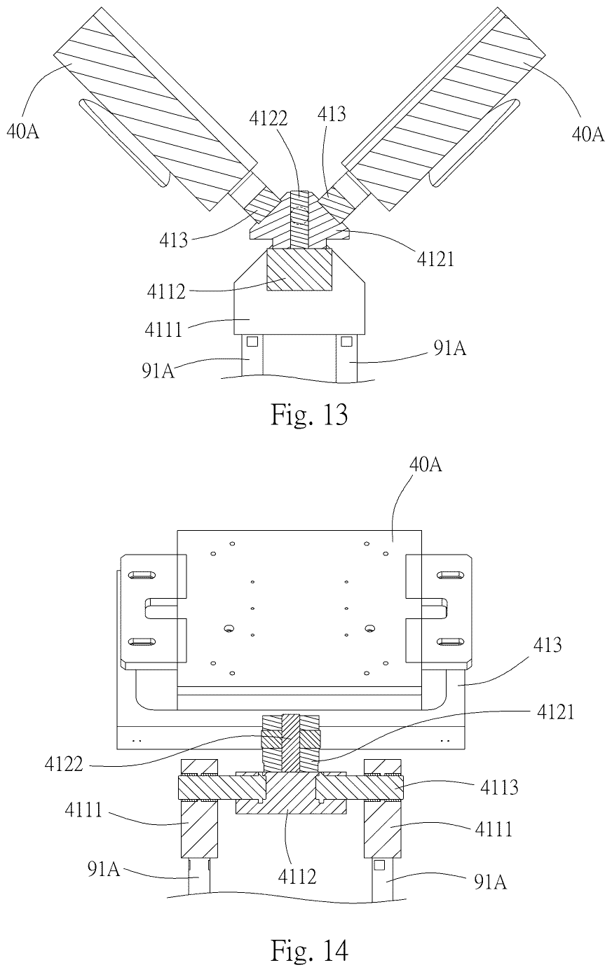

The fixing portion 411 comprises two sleeve seats 4111, a first seat body 4112, and a first rotating shaft 4113. One of the sleeve seats 4111 straddles two guide rods 91A, and the other sleeve seat 4111 straddles the other two guide rods 91A. All the sleeve seats 4111 are parallel. As shown in FIG. 12 and FIG. 14, the first seat body 4112 is disposed among the sleeve seats 4111, rotatably connected to the sleeve seats 4111 through the first rotating shaft 4113, and thus configured to move between different positions to meet mold swapping need and facilitate alignment. As shown in FIG. 11 and FIG. 13, the actuating portion 412 comprises a second seat body 4121 mounted on the fixing portion 411 through a second rotating shaft 4122 and configured to rotate relative to the fixing portion 411 with the second rotating shaft 4122 functioning as the fulcrum, thereby swapping the second molds 40A. The actuating portion 412 is actuated manually or by an automation system. In this embodiment, the actuating portion 412 further comprises another rotating shaft whereby the second seat body 4121 rotates or swings about multiple axial directions and by multiple angles. The disclosure is disclosed above by embodiments. However, persons skilled in the art should understand that the embodiments are illustrative of the disclosure only, but shall not be interpreted as restrictive of the scope of the disclosure. Please note that all simple, equivalent variations and modifications made to the embodiments without departing from the spirit and scope of the disclosure shall be deemed to fall within the scope of the claims of the disclosure.

1. A sole forming device, comprising:
a base;
a first mold having a first mold body and a second mold body, the first and second mold bodies being arranged side by side on the base, the first mold body having a first cavity defined therein and opening outward, and the second mold body having a second cavity defined therein and opening outward;
a linkage mechanism connected to the first mold body and the second mold body and configured to synchronously drive the first mold body and the second mold body to move between a first mold-opening position and a first mold-closing position;
a second mold spaced apart from the first mold and configured to move between a second mold-opening position spaced apart from the first mold and a second mold-closing position abutting the first mold; and
a first shoe last and a second shoe last sleeved by a first fitting member and a second fitting member respectively, arranged side by side, and detachably attached to the second mold, wherein the first and second shoe lasts move synchronously with the second mold away from the first mold when the second mold is at the second mold-opening position, and the first and second shoe lasts are inserted into the first and second cavities respectively when the second mold is at the second mold-closing position,
wherein changing positions of the first mold body and the second mold body causes the linkage mechanism to simultaneously drive the first mold body and the second mold body to move from the first mold-closing position to the first mold-opening position; then changing a position of the second mold causes the second mold to move from the second mold-opening position to the second mold-closing position; and then the linkage mechanism simultaneously drives the first mold body and the second mold body to move from the first mold-opening position to the first mold-closing position to define a first sole forming space between an inner wall surface of the first cavity and an outer periphery of the first shoe last and define a second sole forming space between an inner wall surface of the second cavity and an outer periphery of the second shoe last.

2. The sole forming device of claim 1, wherein the second mold and the first mold move relative to each other along a virtual first axial direction; wherein the first mold body comprises a first mold member, a second mold member, and a third mold member, the first and second mold members being spaced apart and configured to extend along a virtual second axial direction perpendicular to the first axial direction, and the third mold member being disposed between the first mold member and the second mold member; wherein the second mold body comprises a fourth mold member, a fifth mold member, and a sixth mold member, the fourth and fifth mold members being spaced apart and configured to extend along the second axial direction, and the sixth mold member being disposed between the fourth mold member and the fifth mold member; wherein the linkage mechanism is connected to the first mold member, the second mold member, the fourth mold member, and the fifth mold member to drive the first, second, fourth and fifth mold members to be synchronously actuated and move along the second axial direction between the first mold-opening position and the first mold-closing position; wherein, when the first mold member and the second mold member are at the first mold-closing position, the third mold member is clampedly disposed between the first mold member and the second mold member, and the sixth mold member is clampedly disposed between the fourth mold member and the fifth mold member; wherein the first mold member, the second mold member, and the third mold member together define the first cavity, and the first cavity is in communication with an exterior through a first aperture; wherein the fourth mold member, the fifth mold member, and the sixth mold member together define the second cavity, and the second cavity is in communication with the exterior through a second aperture; wherein, when the first and second mold members are at the first mold-opening position, the first and second mold members are positioned distal to the third mold member, and the fourth and fifth mold members are positioned distal to the sixth mold member.

3. The sole forming device of claim 2, wherein the linkage mechanism comprises:
a guide portion extending along the second axial direction;
a first moving portion slidably disposed on the guide portion and configured to carry the first mold body;
a first driving portion configured to drive the first moving portion to slide along the guide portion and drive the first mold body to move together with the first moving portion;
a second moving portion spaced apart from the first moving portion, slidably disposed on the guide portion, and configured to carry the second mold body; and
a second driving portion configured to drive the second moving portion to slide along the guide portion and drive the second mold body to move together with the second moving portion.

4. The sole forming device of claim 3, wherein the guide portion comprises a first guide rod and a second guide rod, the first and second guide rods being parallel, spaced apart, and configured to extend along the second axial direction.

5. The sole forming device of claim 4, wherein the first moving portion comprises a first sliding block and a second sliding block, the first sliding block extending across, being slidably disposed on the first guide rod and the second guide rod, and being configured to carry the first mold member, and the second sliding block being spaced apart from the first sliding block, extending across and being slidably disposed on the first guide rod and the second guide rod, and being configured to carry the second mold member; wherein the second moving portion comprises a third sliding block and a fourth sliding block, the third sliding block extending across, being slidably disposed on the first guide rod and the second guide rod, and being configured to carry the third mold member, and the fourth sliding block being spaced apart from the third sliding block, extending across and being slidably disposed on the first guide rod and the second guide rod, and being configured to carry the fourth mold member.

6. The sole forming device of claim 5, wherein the first driving portion comprises a first power source, a first connecting member, and a first linkage member; wherein the first connecting member is disposed between the first power source and the first sliding block such that the first sliding block is driven by the first power source to move away from or toward the second sliding block; wherein the first linkage member is disposed between the first sliding block and the fourth sliding block and configured to cause the fourth sliding block to move toward the third sliding block when the first sliding block is driven to move toward the second sliding block; wherein the second driving portion comprises a third power source and a second connecting member; wherein the second connecting member is disposed between the third power source and the third sliding block such that the third sliding block is driven by the third power source to move away from or toward the fourth sliding block; wherein the second linkage member is disposed between the third sliding block and the second sliding block and configured to cause the second sliding block to move toward the first sliding block when the third sliding block is driven to move toward the fourth sliding block.

7. The sole forming device of claim 6, wherein the first connecting member comprises a first pivot seat, a second pivot seat, a first swing arm, and a second swing arm, the first and second pivot seats being spaced apart and disposed on the first sliding block, the first swing arm having an end connected to the first pivot seat and another end connected to the first power source, and the second swing arm having an end connected to the second pivot seat and another end connected to the first power source; wherein the second connecting member comprises a third pivot seat, a fourth pivot seat, a third swing arm, and a fourth swing arm, the third and fourth pivot seats being spaced apart and disposed on the third sliding block, the third swing arm having an end connected to the third pivot seat and another end connected to the third power source, and the fourth swing arm having an end connected to the fourth pivot seat and another end connected to the third power source.

8. The sole forming device of claim 6, wherein the first linkage member comprises a first push rod and a second push rod, the first push rod being disposed on the first sliding block, being positioned proximate to the first guide rod, and extending along the second axial direction toward the fourth sliding block, and the second push rod being disposed on the first sliding block, being positioned proximate to the second guide rod, and extending along the second axial direction toward the fourth sliding block; wherein, when the first sliding block moves toward the second sliding block and becomes positioned proximate to the second sliding block, both the first push rod and the second linkage member abut the fourth sliding block, move together with the first sliding block, and push the fourth sliding block to cause the fourth sliding block to move toward the third sliding block; wherein the second linkage member comprises a third push rod and a fourth push rod, the third push rod being disposed on the third sliding block, being positioned proximate to the first guide rod, and extending along the second axial direction toward the second sliding block, and the fourth push rod being disposed on the third sliding block, being positioned proximate to the second guide rod, and extending along the second axial direction toward the second sliding block; wherein, when the third sliding block moves toward the fourth sliding block and becomes positioned proximate to the fourth sliding block, both the third push rod and the fourth linkage member abut the second sliding block, move together with the third sliding block, and push the second sliding block to cause the second sliding block to move toward the first sliding block.

9. The sole forming device of claim 1, wherein the first fitting member and the second fitting member are shoe uppers, or the first fitting member and the second fitting member are shoe-socks.

10. A sole forming method, using the sole forming device of claim 1, the sole forming method comprising:
step a: providing a first mold and a second mold, wherein the second mold is movable between a second mold-opening position spaced apart from the first mold and a second mold-closing position abutting the first mold;
step b: providing a first shoe last and a second shoe last that are respectively sleeved by a first fitting member and a second fitting member, arranged side by side, and detachably attached to the second mold;
step c: changing positions of a first mold body and a second mold body of the first mold through a linkage mechanism so as to move the first mold body and the second mold body from a first mold-closing position to a first mold-opening position;
step d: changing a position of the second mold so as to move the second mold from the second mold-opening position to the second mold-closing position and synchronously move the first shoe last and the second shoe last together with the second mold such that the first shoe last is inserted into the first cavity of the first mold body and the second shoe last is inserted into the second cavity of the second mold body;
step e: simultaneously driving, through the linkage mechanism, the first mold body and the second mold body to move from the first mold-opening position to the first mold-closing position so as to define a first sole forming space between an inner wall surface of the first cavity and an outer periphery of the first shoe last and define a second sole forming space between an inner wall surface of the second cavity and an outer periphery of the second shoe last; and
step f: introducing a first shoe raw material and a second shoe raw material into the first sole forming space and the second sole forming space respectively such that the first shoe raw material integrally encapsulates the first fitting member and the second shoe raw material integrally encapsulates the second fitting member.

11. A sole forming method, using the sole forming device of claim 2, the sole forming method comprising:
step a: providing a first mold and a second mold, wherein the second mold is movable between a second mold-opening position spaced apart from the first mold and a second mold-closing position abutting the first mold;
step b: providing a first shoe last and a second shoe last that are respectively sleeved by a first fitting member and a second fitting member, arranged side by side, and detachably attached to the second mold;
step c: changing positions of a first mold body and a second mold body of the first mold through a linkage mechanism so as to move the first mold body and the second mold body from a first mold-closing position to a first mold-opening position;
step d: changing a position of the second mold so as to move the second mold from the second mold-opening position to the second mold-closing position and synchronously move the first shoe last and the second shoe last together with the second mold such that the first shoe last is inserted into the first cavity of the first mold body and the second shoe last is inserted into the second cavity of the second mold body;
step e: simultaneously driving, through the linkage mechanism, the first mold body and the second mold body to move from the first mold-opening position to the first mold-closing position so as to define a first sole forming space between an inner wall surface of the first cavity and an outer periphery of the first shoe last and define a second sole forming space between an inner wall surface of the second cavity and an outer periphery of the second shoe last; and
step f: introducing a first shoe raw material and a second shoe raw material into the first sole forming space and the second sole forming space respectively such that the first shoe raw material integrally encapsulates the first fitting member and the second shoe raw material integrally encapsulates the second fitting member.

12. A sole forming method, using the sole forming device of claim 3, the sole forming method comprising:
step a: providing a first mold and a second mold, wherein the second mold is movable between a second mold-opening position spaced apart from the first mold and a second mold-closing position abutting the first mold;
step b: providing a first shoe last and a second shoe last that are respectively sleeved by a first fitting member and a second fitting member, arranged side by side, and detachably attached to the second mold;
step c: changing positions of a first mold body and a second mold body of the first mold through a linkage mechanism so as to move the first mold body and the second mold body from a first mold-closing position to a first mold-opening position;
step d: changing a position of the second mold so as to move the second mold from the second mold-opening position to the second mold-closing position and synchronously move the first shoe last and the second shoe last together with the second mold such that the first shoe last is inserted into the first cavity of the first mold body and the second shoe last is inserted into the second cavity of the second mold body;
step e: simultaneously driving, through the linkage mechanism, the first mold body and the second mold body to move from the first mold-opening position to the first mold-closing position so as to define a first sole forming space between an inner wall surface of the first cavity and an outer periphery of the first shoe last and define a second sole forming space between an inner wall surface of the second cavity and an outer periphery of the second shoe last; and
step f: introducing a first shoe raw material and a second shoe raw material into the first sole forming space and the second sole forming space respectively such that the first shoe raw material integrally encapsulates the first fitting member and the second shoe raw material integrally encapsulates the second fitting member.

13. A sole forming method, using the sole forming device of claim 4, the sole forming method comprising:
step a: providing a first mold and a second mold, wherein the second mold is movable between a second mold-opening position spaced apart from the first mold and a second mold-closing position abutting the first mold;
step b: providing a first shoe last and a second shoe last that are respectively sleeved by a first fitting member and a second fitting member, arranged side by side, and detachably attached to the second mold;
step c: changing positions of a first mold body and a second mold body of the first mold through a linkage mechanism so as to move the first mold body and the second mold body from a first mold-closing position to a first mold-opening position;
step d: changing a position of the second mold so as to move the second mold from the second mold-opening position to the second mold-closing position and synchronously move the first shoe last and the second shoe last together with the second mold such that the first shoe last is inserted into the first cavity of the first mold body and the second shoe last is inserted into the second cavity of the second mold body;
step e: simultaneously driving, through the linkage mechanism, the first mold body and the second mold body to move from the first mold-opening position to the first mold-closing position so as to define a first sole forming space between an inner wall surface of the first cavity and an outer periphery of the first shoe last and define a second sole forming space between an inner wall surface of the second cavity and an outer periphery of the second shoe last; and
step f: introducing a first shoe raw material and a second shoe raw material into the first sole forming space and the second sole forming space respectively such that the first shoe raw material integrally encapsulates the first fitting member and the second shoe raw material integrally encapsulates the second fitting member.

14. A sole forming method, using the sole forming device of claim 5, the sole forming method comprising:
step a: providing a first mold and a second mold, wherein the second mold is movable between a second mold-opening position spaced apart from the first mold and a second mold-closing position abutting the first mold;
step b: providing a first shoe last and a second shoe last that are respectively sleeved by a first fitting member and a second fitting member, arranged side by side, and detachably attached to the second mold;
step c: changing positions of a first mold body and a second mold body of the first mold through a linkage mechanism so as to move the first mold body and the second mold body from a first mold-closing position to a first mold-opening position;
step d: changing a position of the second mold so as to move the second mold from the second mold-opening position to the second mold-closing position and synchronously move the first shoe last and the second shoe last together with the second mold such that the first shoe last is inserted into the first cavity of the first mold body and the second shoe last is inserted into the second cavity of the second mold body;
step e: simultaneously driving, through the linkage mechanism, the first mold body and the second mold body to move from the first mold-opening position to the first mold-closing position so as to define a first sole forming space between an inner wall surface of the first cavity and an outer periphery of the first shoe last and define a second sole forming space between an inner wall surface of the second cavity and an outer periphery of the second shoe last; and
step f: introducing a first shoe raw material and a second shoe raw material into the first sole forming space and the second sole forming space respectively such that the first shoe raw material integrally encapsulates the first fitting member and the second shoe raw material integrally encapsulates the second fitting member.

15. A sole forming method, using the sole forming device of claim 6, the sole forming method comprising:
step a: providing a first mold and a second mold, wherein the second mold is movable between a second mold-opening position spaced apart from the first mold and a second mold-closing position abutting the first mold;
step b: providing a first shoe last and a second shoe last that are respectively sleeved by a first fitting member and a second fitting member, arranged side by side, and detachably attached to the second mold;
step c: changing positions of a first mold body and a second mold body of the first mold through a linkage mechanism so as to move the first mold body and the second mold body from a first mold-closing position to a first mold-opening position;
step d: changing a position of the second mold so as to move the second mold from the second mold-opening position to the second mold-closing position and synchronously move the first shoe last and the second shoe last together with the second mold such that the first shoe last is inserted into the first cavity of the first mold body and the second shoe last is inserted into the second cavity of the second mold body;
step e: simultaneously driving, through the linkage mechanism, the first mold body and the second mold body to move from the first mold-opening position to the first mold-closing position so as to define a first sole forming space between an inner wall surface of the first cavity and an outer periphery of the first shoe last and define a second sole forming space between an inner wall surface of the second cavity and an outer periphery of the second shoe last; and
step f: introducing a first shoe raw material and a second shoe raw material into the first sole forming space and the second sole forming space respectively such that the first shoe raw material integrally encapsulates the first fitting member and the second shoe raw material integrally encapsulates the second fitting member.

16. A sole forming method, using the sole forming device of claim 7, the sole forming method comprising:
step a: providing a first mold and a second mold, wherein the second mold is movable between a second mold-opening position spaced apart from the first mold and a second mold-closing position abutting the first mold;
step b: providing a first shoe last and a second shoe last that are respectively sleeved by a first fitting member and a second fitting member, arranged side by side, and detachably attached to the second mold;
step c: changing positions of a first mold body and a second mold body of the first mold through a linkage mechanism so as to move the first mold body and the second mold body from a first mold-closing position to a first mold-opening position;
step d: changing a position of the second mold so as to move the second mold from the second mold-opening position to the second mold-closing position and synchronously move the first shoe last and the second shoe last together with the second mold such that the first shoe last is inserted into the first cavity of the first mold body and the second shoe last is inserted into the second cavity of the second mold body;
step e: simultaneously driving, through the linkage mechanism, the first mold body and the second mold body to move from the first mold-opening position to the first mold-closing position so as to define a first sole forming space between an inner wall surface of the first cavity and an outer periphery of the first shoe last and define a second sole forming space between an inner wall surface of the second cavity and an outer periphery of the second shoe last; and
step f: introducing a first shoe raw material and a second shoe raw material into the first sole forming space and the second sole forming space respectively such that the first shoe raw material integrally encapsulates the first fitting member and the second shoe raw material integrally encapsulates the second fitting member.

17. A sole forming method, using the sole forming device of claim 8, the sole forming method comprising:
step a: providing a first mold and a second mold, wherein the second mold is movable between a second mold-opening position spaced apart from the first mold and a second mold-closing position abutting the first mold;
step b: providing a first shoe last and a second shoe last that are respectively sleeved by a first fitting member and a second fitting member, arranged side by side, and detachably attached to the second mold;
step c: changing positions of a first mold body and a second mold body of the first mold through a linkage mechanism so as to move the first mold body and the second mold body from a first mold-closing position to a first mold-opening position;
step d: changing a position of the second mold so as to move the second mold from the second mold-opening position to the second mold-closing position and synchronously move the first shoe last and the second shoe last together with the second mold such that the first shoe last is inserted into the first cavity of the first mold body and the second shoe last is inserted into the second cavity of the second mold body;
step e: simultaneously driving, through the linkage mechanism, the first mold body and the second mold body to move from the first mold-opening position to the first mold-closing position so as to define a first sole forming space between an inner wall surface of the first cavity and an outer periphery of the first shoe last and define a second sole forming space between an inner wall surface of the second cavity and an outer periphery of the second shoe last; and
step f: introducing a first shoe raw material and a second shoe raw material into the first sole forming space and the second sole forming space respectively such that the first shoe raw material integrally encapsulates the first fitting member and the second shoe raw material integrally encapsulates the second fitting member.

18. A sole forming method, using the sole forming device of claim 9, the sole forming method comprising:
step a: providing a first mold and a second mold, wherein the second mold is movable between a second mold-opening position spaced apart from the first mold and a second mold-closing position abutting the first mold;
step b: providing a first shoe last and a second shoe last that are respectively sleeved by a first fitting member and a second fitting member, arranged side by side, and detachably attached to the second mold;
step c: changing positions of a first mold body and a second mold body of the first mold through a linkage mechanism so as to move the first mold body and the second mold body from a first mold-closing position to a first mold-opening position;
step d: changing a position of the second mold so as to move the second mold from the second mold-opening position to the second mold-closing position and synchronously move the first shoe last and the second shoe last together with the second mold such that the first shoe last is inserted into the first cavity of the first mold body and the second shoe last is inserted into the second cavity of the second mold body;
step e: simultaneously driving, through the linkage mechanism, the first mold body and the second mold body to move from the first mold-opening position to the first mold-closing position so as to define a first sole forming space between an inner wall surface of the first cavity and an outer periphery of the first shoe last and define a second sole forming space between an inner wall surface of the second cavity and an outer periphery of the second shoe last; and
step f: introducing a first shoe raw material and a second shoe raw material into the first sole forming space and the second sole forming space respectively such that the first shoe raw material integrally encapsulates the first fitting member and the second shoe raw material integrally encapsulates the second fitting member.
